(19) United States
(12) Patent Application Publication
(10) Pub. No.: US 2008/0254646 A1
(43) Pub. Date: Oct. 16, 2008

(54) Electrical connecting device

(76) Inventors: Erik Reischl, Birkenfeld (DE); Sven Kuerschner, Woellstein (DE); Dieter Kurz, Bacharach/Steg (DE); Peter Leng, Mainz (DE)

Correspondence Address: DELPHI TECHNOLOGIES, INC., M/C 480-410-202, PO BOX 5052, TROY, MI, 48007, US

(21) Appl. No.: 12/082,035

(22) Filed: Apr. 8, 2008

(30) Foreign Application Priority Data
Apr. 14, 2007 (EP) 07007654.2

(51) Int. Cl. H01R 39/00

(52) U.S. Cl. 439/15

(57) ABSTRACT

An electrical connecting device, in particular for arrangement between steering wheel and steering column switch module of a motor vehicle, comprises a stationary housing portion and a housing portion rotatable relative thereto, which in each case carry a terminal unit and surround at least one spirally wound flexible electrical wire which is in each case connected terminally to the terminal units and guided in a direction-changing loop within the housing. At least one additional, spirally wound, flexible electrical wire is provided, which is connected to the terminal units and which is guided in a direction-reversing loop within the housing.

### TECHNICAL FIELD

The present invention relates to an electrical connecting device, in particular for arrangement between the steering wheel and steering column switch module of a motor vehicle, having a stationary housing portion and a housing portion rotatable relative thereto, which in each case carry a terminal unit and surround at least one spirally wound flexible electrical wire which is in each case connected terminally to the terminal units and guided in a direction-changing loop within the housing.

### BACKGROUND OF THE INVENTION

Connecting devices of this kind are used in particular for making electrical connections between a current source and a gas collision protection device such as an air bag restraint arranged in the steering wheel dish or steering wheel switches of motor vehicles. Here, a wire arranged between the stator portion and the rotor portion which is rotatable relative thereto has a length such that it can follow the steering deflection, which is about three turns in both directions, wherein during steering wheel deflection the flexible wire expands outwards from a central position in one direction until it abuts against the stator portion and contracts inwards in the other direction until it abuts against the rotor portion. Furthermore it is known that the wire can be assigned positive restraint which is applied to the wire circumferentially and, on rotational movement of the rotor portion, causes predefined winding and unwinding of the wire.

EP 0 556 779 B2 discloses an electrical connecting device having an inner housing and an outer housing which consist of two relatively rotatable components. The connecting device has a flexible and spirally wound transmission medium which is accommodated in a chamber formed by the two housing portions. The transmission medium includes inner and outer ends which are attached to the inner and outer housings respectively, and inner and outer end sections which extend in opposite directions to each other round the circumference of the inner and outer housings, so that between the inner and outer end sections is formed a cable movement-reversing section in which the direction of movement of the transmission medium is reversed. In the chamber formed by the inner and outer housings there are a plurality of flexible cables including at least one transmission cable which serves as a transmission medium and at least one non-transmission dummy cable. Each of the cables has its own inner and outer ends which are attached to the inner and outer housings respectively. The inner and outer end sections of the cables extend in opposite directions to each other round the circumference of the inner and outer housings, so that between the inner and outer end sections are formed cable movement-reversing sections spaced apart at intervals from each other. Furthermore, the inner and outer end sections of the cables are fixed at a distance from each other.

### SUMMARY OF THE INVENTION

It is the object of the invention to provide an electrical connecting device of the kind mentioned hereinbefore which ensures the transmission of a plurality of signals with high reliability.

According to the invention, the object is achieved by the fact that at least one additional, spirally wound, flexible electrical wire is provided, which is connected to the terminal units and which is guided in a direction-reversing loop within the housing.

On account of the fact that in the housing are provided two electrical wires which are electroconductively connected to the two terminal units, with the connecting device which works by the so-called short-band technique, the transmission of a plurality of signals is ensured with high reliability. The wiring of the two wires can be for example parallel to each other, that is, redundant, or different current paths of the wires contact different terminal contacts, whereby the number of signals to be transmitted, for example between a motor vehicle's electrical system and a steering wheel, is higher than if a wire is used with the same height of the connecting device.

Appropriately there are provided three additional electrical wires which are coupled to the terminal units.

Preferably the additional wires are wound and connected parallel to the first wire. Thus a total of three wires are available, which are connected to the terminal units parallel to the first wire, guaranteeing a relatively high degree of transmission safety. To achieve functionally favourable winding and unwinding of the wires about a hub of the housing, the direction-reversing loops of the wires are arranged uniformly spaced apart from each other in the housing.

In an embodiment the first wire is welded to pressed screens of the terminal units. Welding achieves a relatively reliable and long-lasting connection which can withstand high loads and yet is relatively cheap to make. To provide a safe terminal connection of the second wire, the second wire is held on socket pins in the welding region of the first wire and comprises a clamping portion which is held by a fixing portion of the terminal unit. According to a development, the fixing portion includes conducting elements to ensure electrical contacting of the first wire and second wire with the associated pressed screen. Naturally the second wire can also be held on the associated terminal unit by the fixing portion without a clamping portion. Preferably, above the fixing portion the third wire and the fourth wire are held in each case on socket pins, located one above the other, the third wire contacting the corresponding pressed screens and the fourth wire contacting the third wire by touch. Electrical contact of the second, third and fourth wires is made by a socket-type, pressed, welded, soldered or adhered connection either to a corresponding pressed screen or current paths of the respectively adjacent wire.

It goes without saying that the characteristics that have been mentioned above and will be described below can be used not only in the given combination, but also in other combinations. The scope of the invention is defined only by the claims.

### BRIEF DESCRIPTION OF THE DRAWINGS

The invention is described in more detail below with the aid of a practical example with reference to the associated drawings. They show:

FIG. 1 is a simplified top view of the electrical connecting device according to the invention, and

FIG. 2 is a perspective view of the connecting device according to FIG. 1.

### DESCRIPTION OF THE PREFERRED EMBODIMENT

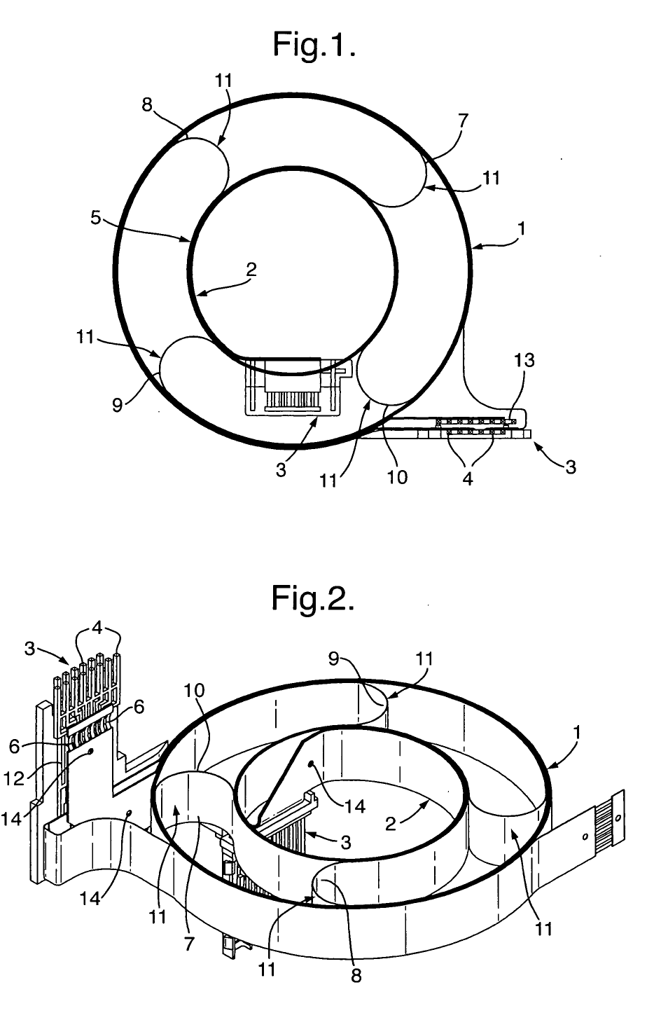

Referring to FIGS. 1 and 2, the electrical connecting device embodying the present invention includes a stationary housing portion 1 and a housing portion 2 rotatable relative thereto, which in each case carry a terminal unit 3, the terminal units 3 which comprise terminal contacts 4 being coupled firstly on the stator side to an electrical system of a motor vehicle and secondly on the rotor side to devices on the steering wheel side. Within the two housing portions 1, 2 which form a housing, four wires 7, 8, 9, 10 each comprising several current paths 6 are spirally wound round a hub 5 oriented coaxially with a steering spindle and guided in direction-changing loops 11 within the housing, the loops 11 of the wires 7, 8, 9, 10 being arranged in the housing uniformly spaced apart from each other circumferentially.

For the transmission of electrical signals between the terminal units 3, the first wire 7 is in each case terminally welded to pressed screens 12 of the terminal units 3 comprising the terminal contacts 4. To ensure signal transmission in case of failure of the first wire 7 or provide additional current paths 6 for the transmission of additional signals, the second wire 8 is kept with its free ends in each case in contact with the corresponding pressed screens 12 by a fixing portion 13 of the terminal units 3. Above the fixing portion 13 the third wire 9 and the fourth wire 10 are located one above the other, the fourth wire 10 contacting the pressed screen 12 via the other wires 7, 8, 9. In order to fix the wires 7, 8, 9, 10 to the terminal units 3, socket pins 14 are provided.

1. Electrical connecting device, in particular for arrangement between steering wheel and steering-column switch module of a motor vehicle, having a stationary housing portion and a housing portion rotatable relative thereto, which in each case carry a terminal unit and surround at least one spirally wound flexible electrical wire which is in each case connected terminally to the terminal units and guided in a direction-changing loop within the housing, wherein at least one additional, spirally wound, flexible electrical wire is provided, which is connected to the terminal units and which is guided in a direction-reversing loop within the housing.

2. Connecting device according to claim 1, further comprising three additional electrical wires which are coupled to the terminal units.

3. Connecting device according to claim 2, wherein the additional wires are wound and connected parallel to the first wire.

4. Connecting device according to claim 2, wherein each said additional wire has a direction-reversing loop, and wherein direction-reversing loops of the wires are arranged uniformly spaced apart from each other in the housing.

5. Connecting device according to claim 1, wherein the first wire is welded to pressed screens of the terminal units.

6. Connecting device according to claim 2, wherein the second wire is held on socket pins in the welding region of the first wire and comprises a clamping portion which is held by a fixing portion of the terminal unit.

7. Connecting device according to claim 6, wherein the fixing portion includes conducting elements to ensure electrical contacting of the first wire and second wire with the associated pressed screen.

8. Connecting device according to claim 6, wherein the fixing portion of the third wire and the fourth wire are held in each case on socket pins, located one above the other, the third wire contacting the corresponding pressed screens and the fourth wire contacting the third wire by touch.

9. Connecting device according to claim 2, wherein each wire comprises several, in particular eight current paths, which run parallel to each other between the terminal contacts and which are sheathed in fully insulating relationship, leaving their terminal region free.

10. A device for electrically interconnecting relatively rotatable components, said device comprising:
a stator housing portion including a first terminal unit adapted to be fixedly carried with one of said components;
a rotor housing portion including a second terminal unit adapted to be fixedly carried with the other of said components, said rotor housing portion concentrically disposed within said stator housing portion and radially spaced therefrom by an annular cavity; and
a plurality of flexible electrical conductors, each said conductor interconnecting said first and second terminal units, spiral wound within said cavity and including a direction-reversing loop, to establish a plurality of parallel electrically conductive paths between said first and second terminal units.
